(19) United States
(12) Patent Application Publication
(10) Pub. No.: US 2005/0061157 A1
(43) Pub. Date: Mar. 24, 2005

(54) Beverage energizing far-infrared sticker

(76) Inventor: Albert C. Wey, Westmont, IL (US)

Correspondence Address: Albert C. Wey, 233 E. 57th Street, Westmont, IL, 60559-2080, US

(21) Appl. No.: 10/643,325

(22) Filed: Aug. 19, 2003

(51) Int. Cl. A23L 1/00

(52) U.S. Cl. 99/275

(57) ABSTRACT

This invention relates to a piece of adhesive sticker that can be attached to a coaster or a beverage serving means for energizing alcoholic or non-alcoholic beverages at or before serving comprising a far infrared ray emitting material that can activate molecular and intermolecular bonds of water and the dissolved substances in the beverage with far infrared emissions, thereby their effects are evident in improved tastes of the beverages.

### BACKGROUND

1. Field of Invention

This invention relates to an adhesive sticker that can be attached to a coaster or exterior of a beverage serving means for energizing alcoholic or non-alcoholic beverages at or before serving comprising a far infrared emitting material that can activate molecular and intermolecular bonds of water and dissolved substances in the beverage, thereby their effects are evident in improved tastes of the beverage.

2. Description of Prior Art

There have been a number of inventions for manufacturing far infrared radiating materials (e.g. U.S. Pat. No. 5,643,489 & 5,707,911) and applications of such materials for improving tastes of beverages (e.g., U.S. Pat. No. 5,965,007, and 5,943,950). However, they require either direct contacting far infrared ray emitting ceramic material with water and/or at a predetermined ceramic/water weight ratio, say 10% or more, in order to provide a noticeable improvement. Other inventions teach the use of far infrared radiation in improving tastes of beverages (e.g. U.S. Pat. No. 4,738,858, and 6,085,637). Nevertheless, all they require the use of far infrared radiating material in a heated environment in order to demonstrate the effect. Therefore, none of prior arts provides a teaching in how the far infrared radiation can be applied for improving tastes in a form of a sticker as described in this invention, which can be placed at proximity of a beverage without the need of direct contact.

According to Organic Chemistry, there exist various kinds of intermolecular interactions among ions and molecules in liquid that explain how liquid is formed and how substances may be dissolved in it. These intermolecular forces include “ion-dipole forces”, “hydrogen-bonding”, “dipole-dipole forces”, and “dipole-induced dipole forces”.

Water is a perfect solvent. Water molecule (H₂O) is essentially a dipole, which may attract each other by “hydrogen-bonding” to form large clusters. Depending on the levels and distribution of kinetic energies, clusters consisting of 11-16 water molecules in a group are not uncommon in the water of our daily uses. Alcohols and ethers also contain hydrogen-bonding. In fact, it is because of hydrogen-bonding that alcohols or ethers can be blended in water at any ratio.

Ions (such as Na⁺,Cl⁻,K⁺,Mg⁺,CO₃⁻² etc.) are bound to water by means of “ion-dipole forces”, while non-polarized molecules such as oxygen (O₂) are dissolved in water via a “dipole-induced dipole force”. Meanwhile, most organic compounds are polarized dipoles and can be dissolved in water by way of a rather weak “dipole-dipole force”. The interaction between the water and these substances not only causes them to dissolve but also greatly influences the properties of water.

It is truly the substances dissolved in water that determine the tastes of beverages. For instance, wines are characterized by the balanced tastes between alcohols, tannins, acidity, sugar, concentrated fruits, and other chemicals. However, how the tastes are sensed strongly depends on the concentration of each individual chemical constituent and the way it stimulates our taste buds. Thanks to aforementioned intermolecular interactions, molecules of the substances in beverage are gathered to form clusters. The larger the cluster size is, the stronger it stimulates the taste nerve. As a consequence, bitter tannins usually dominates the taste of a young wine, in which aging may be the only way to soft its bitterness.

It has been studied and described in the Infrared Absorption section of Organic Chemistry that infrared radiation causes excitation of the quantized molecular vibration states. In an organic compound molecule, for example, each bond (such as C—H) or each group of three or more atoms (such as CH₂ or CH₃) absorbs IR radiation at certain frequencies to set off stretching and bending vibrations. Only vibrations that cause a change in dipole moment give rise to an absorption band. It is reported that the larger the change in dipole moment is, the stronger the absorption may be.

It is also found that most common functional groups (i.e. OH, NH, CH, C═O, COOH, C≡C, C≡N) appear at the high-energy region (i.e. high frequency or low wavelength) of IR spectrum, usually between 1,400-4,000 cm⁻¹ in frequency (or 2.5-7.0 μm in wavelength). This happens to fall partially in “medium-infrared” and mostly in “far-infrared” radiation zones. This region is called the “functional group region”, which is shown in Table 1.

Technically speaking, “infrared” is a general phrase that is referred to the electromagnetic waves whose wavelengths are in 0.83 μm-1,000 μm. Conventionally, it is divided into three convenient zones: “near infrared” at 0.83-2.0 μm, “medium i [symbol] ” at 2.0-4.0 μm, and “far infrared [symbol] i-1,000 μm. For simplicity, “far-infrared” is often used to imply the wavelength band 2.5-1,000 μm in order to distinguish itself from the widespread term “infrared” which has been a common synonymy of “near infrared” at 0.83-2.0 μm. From now on in this patent application, we will use the word “far infrared” to represent emissions whose wavelengths are in 2.5-1,000 μm.

TABLE 1
IR absorption spectrum of exemplar functional groups.

| Functional Group | Bond | IR absorption band (μm) |
|---|---|---|
| water | O—H••••• O | 2.94-3.12 |
| alcohols and water | O—H | 2.77-3.03 |
| ethers | O═C—O—C | 5.61-5.83 |
| Carboxlic acids | O═C—O—H | 3.03-4.00 |
| | O═C—OH | 5.80-5.95 |
| amines | N—H | 2.82-3.03 |
| amides | O═C—N— (I) | 5.88-6.00 |
| | O═C—N— (II) | 6.45-6.42 |
| nitriles | C≡N | 4.42-4.56 |
| Acid chlorides | O═C—Cl | 5.51-5.71 |
| Acid anhydrides | (O═C)₂O | 5.59-5.85 |
| Aromatic rings | C—H | 3.23-3.33 |
| | C═C | 6.25-6.90 |
| Benzene derivatives | Ar—H | 3.29-3.32 |
| | Ar C═C | 6.25-6.63 |
| Sulfonic acid derivatives | S—H | 3.95-4.00 |

According to Table 1, when water molecules are irradiated with far infrared emissions at wavelengths in 2.77-3.12 μm, the valence bond (O—H) between oxygen atom (O) and hydrogen atom (H) of the water will be activated to stretch, so does the intermolecular hydrogen bond between two adjacent water molecules. As a result of kinetically vibrational stretch of these bonds, water molecules have tendency to defeat the intermolecular bonding forces and separate themselves from other companions in the cluster to form a smaller assembly. This is the reason why far infrared radiation is said to be able to break apart large water clusters into smaller groups. Similar IR-caused bond-stretching and bond-bending activities can be found in other functional groups, as described in Table 1.

Thereby, it is our finding that exposing far infrared radiation in the wavelength band of 2.5-7 μm as a whole to beverage can energize molecules of water and the substances dissolved within. The photon energy of far-infrared radiation can be passed on to the recipient to increase its level of kinetic energy. The receiving molecules are energized to create vigorous bond-stretching and bond-bending. Consequently, these molecules resonantly vibrate constantly and can prevent themselves from forming stagnate large clusters.

After being illuminated by far infrared rays, the molecules in beverage are regrouped to form smaller constellation and redistributed themselves uniformly throughout the body. Thereafter, the curtailed clusters will not excite the taste nerve as much as their predecessors, resulting in a smoother taste. For instance, when a young wine is exposed to far infrared emissions, the constituent parts of the wine are instantaneously realigned in the same way as a long-run bottle aging would do to the wine, evident in a silky texture and diminishing tannins.

In addition to improve tastes, far infrared-energized beverages can also be therapeutically beneficial to human body, in which circulating blood carries hundreds of vital substance around, such as sugar, proteins, ions, vitamins, minerals, wastes, hormones, germ-fighting chemicals, oxygen, carbon dioxides, etc. Now, the far-infrared energized, smaller size water clusters that constitute blood plasma and body fluids become highly mobile and penetrative and can help bring nutrients to the cells and carry away wastes more efficiently, or, in other words, improved metabolism.

As described before, the application of far infrared radiation for improving tastes of beverages may not be new. However, the radiation indices of conventional far infrared materials used in the prior art are very low, particularly at the lower end of IR spectrum, namely 2.5-5 μm. As a result, the far infrared radiation strength used in the prior art was so little that they had to require submerging a bulky far infrared radiating material in beverage in order to demonstrate the effect. Besides, it is well expected that not only radiation strength is proportional to the forth order of temperature (Stefan-Beltzmann Law) but also the wavelength of peak radiation reduces as temperature increases (Wein Displacement Law). Therefore, the ceramic materials used in the quoted prior art have to be heated in order to boost low-wavelength radiation for energizing water and the dissolved substances.

The present inventor has undertaken extensive studies to develop a far infrared radiating body possessing a stronger radiation capacity in the desirable band of wavelengths, namely 2.5 to 7 μm. The inventor found that the most effective far infrared radiation could be obtained when the ceramic materials were made of powders typically composed of oxides selected from the group consisting alumina, silica, alumina hydrate, silica hydrate, zirconia, lithium oxide, magnesium oxide, calcium oxide, titanium oxide, or the like. An appropriate amount of transition metal oxides can be added to the mixture in order to enhance the radiation, particularly at the highly desirable low-wavelengths portion.

The far infrared ray emitting body made of such materials can effectively transfer ambient heat into far infrared radiation without a need of an outside energy source of any sort. Therefore, heating the material at an elevated temperature will not be necessary. Meanwhile, as the radiation strength of this far infrared radiation material is extraordinary, it makes possible using only a thin coating of such material on the surface of a self-adhesive sheet that may emit enough photon energy for the intended purpose.

Therefore, This invention relates to an adhesive sticker that can be attached to coaster or a beverage serving means for energizing alcoholic or non-alcoholic beverages at or before serving comprising a far infrared ray emitting material that can activate molecular and intermolecular bonds of water and the substances dissolved in the beverage with far infrared emissions at wavelengths 2.5-7 μm, thereby their effects are evident in improved tastes of these beverages.

### OBJECTS AND ADVANTAGES

Accordingly, one object of this invention is to provide a convenient beverage energizing means that can effectively improve the beverage's taste instantly whenever the beverage is served and in all possible occasions.

Another object of the present invention is to provide a simple and yet effective beverage energizing means that requires no heating or any outside energy source.

These objectives are achieved by a beverage-energizing sticker comprising a far infrared ray emitting material, which can be attached to any beverage serving means.

Other objects, features and advantages of the present invention will hereinafter become apparent to those skilled in the art from the following description.

### DRAWING FIGURES

FIG. 1 shows a cutaway perspective view of one embodiment of the present invention with the far infrared ray emitting material uniformly disposed on a pliable sheet over an adhesive layer.

FIG. 2 shows one embodiment of the present invention in a form of a sticker as shown in FIG. 1, which is attached to and become part of a mug.

FIG. 3 shows one embodiment of the present invention in a form of a sticker as shown in FIG. 1, which is attached to and become part of a water bottle.

FIG. 4 shows one embodiment of the present invention in a form of a sticker as shown in FIG. 1, which is attached to and become part of a pitcher.

FIG. 5 shows one embodiment of the present invention in a form of a sticker as shown in FIG. 1, which is attached to and become part of a wine decanter.

FIG. 6 shows one embodiment of the present invention in a form of a sticker as shown in FIG. 1, which is attached to and become part of a coaster.

### REFERENCE NUMERALS IN DRAWINGS

| | | | |
|---|---|---|---|
| 11 | Far infrared ray emitting material layer | 12 | pliable supporting |
| | | | layer |
| 13 | Adhesive layer | 21 | Far infrared ray em- |
| | | | ittiing sticker |

### SUMMARY

In accordance with the present invention a beverage energizing means in the form of a sticker comprises a layer of far infrared ray emitting material made of far infrared ray emitting powders having radiation capacity in the wavelengths 2.5-7 μm. The beverage-energizing sticker can be attached to any beverage serving means for energizing the beverage before or at serving to improve its taste, without a need of an outside energy source of any sort.

### DETAILED DESCRIPTION OF THE INVENTION

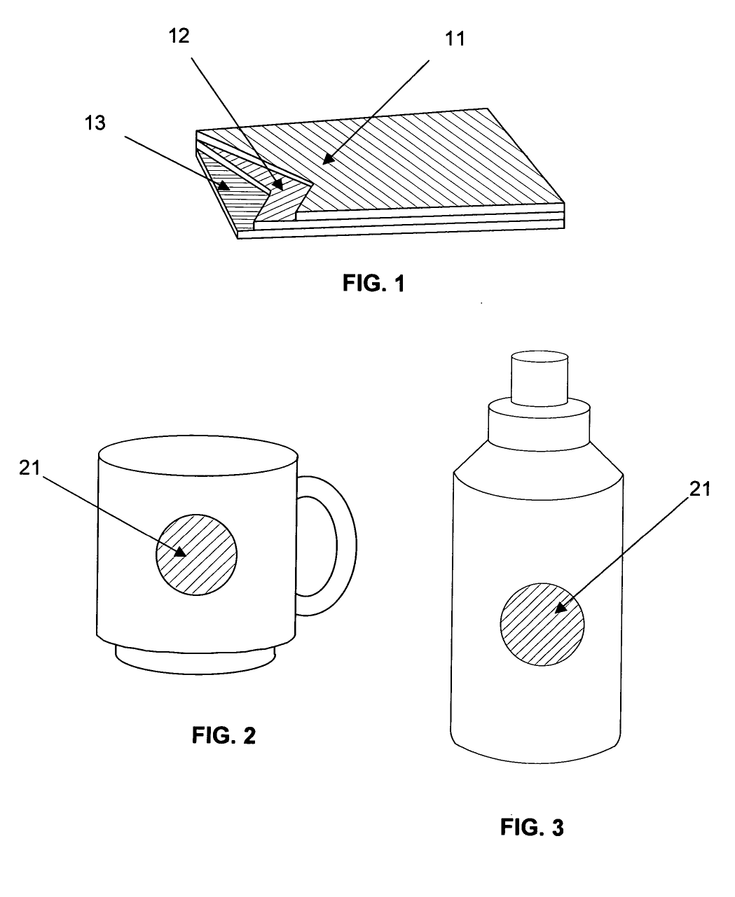

FIG. 1 shows a cutaway perspective view of one embodiment of the present invention, in which a far infrared ray emitting material 11 is disposed on a pliable sheet 12 over a self-adhesive layer 13. The ceramic powder can be uniformly coated or printed on the pliable sheet 12 as shown in FIG. 1. It can also be impregnated. Said far infrared ray emitting material 11 can be disposed on said pliable sheet 12 by deposition, sputtering or any other known techniques. The material for pliable sheet can be paper, rubber, plastics, leather, woven fabrics, resin coated cloth, various synthetic resin films, or the like. The final assembly constitutes a self-adhesive far infrared radiating sticker 21, which can take any shapes, forms, styles, patterns, and in any thickness.

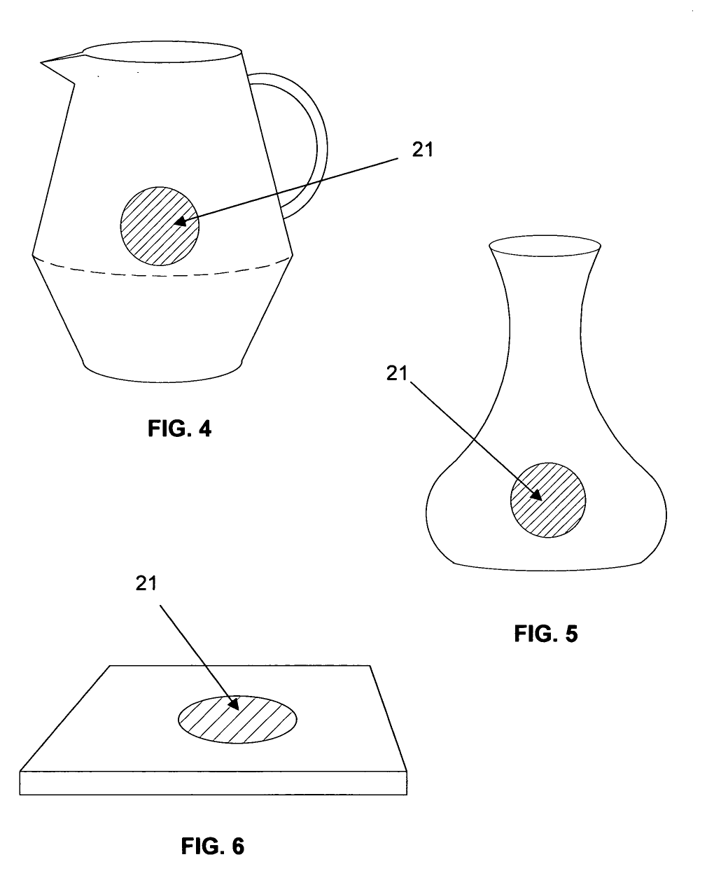

This sticker-like self-adhesive far infrared radiating device 21 can be placed on any beverage serving means that can be brought to proximity of the beverage before and at serving. For example, the sticker can be placed on a coffee or beer mug as shown in FIG. 2. FIG. 3 shows the sticker is attached to a water bottle, while FIG. 4 shows that it is glued to a pitcher. In FIG. 5, the sticker is placed on a wine decanter to provide simulated aging for the wine contained within so that the wine may taste like a matured fine wine with silky texture and diminishing tannins. The sticker can also be disposed on a coaster, as shown in FIG. 6, so that the improved tastes can be preserved through the course of enjoying the beverage.

### EXAMPLE

The present inventor has undertaken extensive studies and developed a far infrared radiating body possessing a stronger radiation capacity in the desirable band of wavelengths, namely 2.5 to 7 μm, in room or chilled temperature.

The far infrared ray emitting particles were made of ceramic composition consisting of alumina, silica, and selective transition metal oxides from zirconia, lithium oxide, magnesium oxide, calcium oxide, titanium oxide, or the like. An appropriate amount of transition metal oxides were added to the mixture to enhance the radiation strength, particularly at lower wavelength end. These particles were coated on a woven fabric by printing. A layer of adhesive material was affixed to the other side of the fabric. The final assembly was then tailored into rectangular stickers having a dimension of 4.5 mm long and 3.7 mm wide. The total thickness of each sticker was about 0.2 mm.

The stickers were placed on a wine decanter as shown in FIG. 5 and some coasters as shown in FIG. 6. A variety of young red wines including Pinot Noir, Cabernet Sauvignon, Merlot, and Beaujolais were used for tasting. During the blind tasting, the wine was poured into a decanter with the sticker of present invention and into a regular decanter. The two were evaluated by a group of tasters following a typical wine tasting process. As a result, the wine that had been exposed to far infrared rays apparently scored better, with a consensus of experiencing a silky texture and diminishing tannins as in that which would be characterized as a mature wine.

Similar tests were also conducted on a 12-year old Chivas Regal, a popular Scotch whisky. It was the tasters' opinions that it tasted rather like an 18-year old one.

It was also found that far infrared treated beverages, such as milk, lemonades, juices, soda, and water were tasted fresher and smoother than the untreated counterparts.

Conclusion, Ramifications, and Scope

According to the present invention, a beverage energizing means comprising a far infrared ray emitting material disposed in a form of sticker that can be attached to any beverage serving means can effectively energize the beverage and improve its tastes before or at serving.

The invention has been described above. Obviously, numerous modifications and variations of the present invention are possible in light of the above teachings. Such variations are not to be regarded as a departure from the spirit and scope of the invention and all such modifications as would be obvious to one skilled in the art are intended to be included within the scope of the following claims.

1. A beverage energizing sticker, comprising:
a sheet-like carrier;
a far infrared ray emitting material disposed on or in the said sheet-like carrier, said far infrared ray emitting material consisting of far infrared ray emitting particles having a radiation capacity in the band of wavelengths between 2.5 and 7 microns; and
an affixing means disposing said carrier on a beverage serving means.

2. The device according to claim 1 wherein the said particles are selected from the group consisting of alumina, silica, zirconia, lithium oxide, magnesium oxide, calcium oxide, titanium oxide, and the like.

3. The device according to claim 1 wherein said carrier comprises a woven fabric.

4. The device according to claim 1 wherein said carrier comprises a cloth material.

5. The device according to claim 1 wherein said carrier comprises a rubber material.

6. The device according to claim 1 wherein said carrier comprises a plastic material.

7. The device according to claim 1 wherein said carrier comprises a synthetic resin material.

8. The device according to claim 1 wherein said carrier comprises a leather material.

9. The device according to claim 1 wherein said carrier comprises a paper material.

10. The device according to claim 1 wherein said affixing means comprises an adhesive material.

11. A method for energizing beverage, comprising:
providing a sheet-like carrier;
coating or impregnating said sheet-like carrier with far infrared ray emitting material, said far infrared ray emitting material being made of far infrared ray emitting particles having a radiation capacity in the band of wavelengths between 2.5 and 7 microns; and
disposing said carrier around a beverage.

12. A method for energizing beverage, comprising:
providing a plate-like carrier;
coating or impregnating said plate-like carrier with far infrared ray emitting material, said far infrared ray emitting material being made of far infrared ray emitting particles having a radiation capacity in the band of wavelengths between 2.5 and 7 microns; and
disposing said carrier around a beverage.
